(19) United States
(12) Patent Application Publication
(10) Pub. No.: US 2010/0246412 A1
(43) Pub. Date: Sep. 30, 2010

(54) ETHERNET OAM FAULT PROPAGATION USING Y.1731/802.1AG PROTOCOL

(75) Inventors: Benjamin D. Washam, Ottawa (CA); Lei Qiu, Pleasanton (CA); Xiaomei Han, Ashton (CA)

Correspondence Address: Terry W. Kramer, Esq.;Kramer & Amado, P.C., 1725 Duke Street, Suite 240, Alexandria, VA, 22314, US

(73) Assignee: ALCATEL LUCENT, Paris (FR)

(21) Appl. No.: 12/413,274

(22) Filed: Mar. 27, 2009

(51) Int. Cl. H04L 12/24

(52) U.S. Cl. 370/248

(57) ABSTRACT

Various exemplary embodiments relate to a method and related network node and machine-readable medium including one or more of the following: receiving a first indication of the existence of a fault in a connection related to a service provided by the node on which the maintenance endpoint is configured; determining that the connection related to the service provided by the node is located outside the scope of the maintenance association by determining that at least one node at which the connection having the fault terminates does not include a maintenance endpoint belonging to the maintenance association; constructing a message packet, the message packet including a second indication of the existence of the fault; and transmitting the message packet to the at least one peer maintenance endpoint within the maintenance association.

### TECHNICAL FIELD

Embodiments disclosed herein relate generally to implementation of Ethernet Operations, Administration, and Maintenance (OAM).

### BACKGROUND

Traditional Local Area Networks (LANs) exchange data using Ethernet, a frame-based standard that allows high-speed transmission of data over a physical line. Since its initial implementation, the Ethernet standard has rapidly evolved and currently accommodates in excess of 10 Gigabits/second. Furthermore, because Ethernet is widely used, the hardware necessary to implement Ethernet data transfers has significantly reduced in price, making Ethernet a preferred standard for implementation of enterprise-level networks.

Given these benefits, telecommunications service providers have sought to expand the use of Ethernet into larger-scale networks, often referred to as Metropolitan Area Networks (MANs) or Wide Area Networks (WANs). By implementing so-called Carrier Ethernet, service providers may significantly increase the capacity of their networks at a minimal cost. This increase in capacity, in turn, enables provider networks to accommodate the large volume of traffic necessary for next-generation applications, such as Voice over Internet Protocol (VoIP), IP Television (IPTV), and Video On Demand (VoD).

Because Ethernet evolved in the context of local area networks, however, native Ethernet has a number of limitations when applied to larger scale networks. One key deficiency is the lack of native support for Operation and Maintenance (OAM) functionality. More specifically, because network operators can typically diagnose problems in a LAN on-site, the Ethernet standard lacks support for remote monitoring of connections and performance. Without support for such remote monitoring, network operators of large-scale networks would find it difficult, if not impossible, to reliably maintain their networks.

To address the lack of native Connectivity Fault Management in the Ethernet standard, several organizations have developed additional standards describing this functionality. In particular, the International Telecommunication Union (ITU) has published Y.1731, entitled, “OAM Functions and Mechanisms For Ethernet-Based Networks,” the entire contents of which are hereby incorporated by reference. Similarly, the Institute of Electrical and Electronics Engineers (IEEE) has published 802.1ag, entitled “Connectivity Fault Management,” the entire contents of which are hereby incorporated by reference.

Y.1731 and 802.1ag describe a number of mechanisms used to detect, isolate, and remedy defects in Ethernet networks. For example, these standards describe the use of Continuity Check Messages (CCMs) that may be periodically transmitted by a network node throughout the network, thereby informing other nodes of its status. Additionally, the receipt of a CCM by one node inherently affirms that the node remains in communication with the sending node. The standards describe similar mechanisms for verifying the location of a fault in the network.

The mechanisms of Y.1731 and 802.1ag are directed toward managing connectivity faults within preconfigured maintenance associations, giving little to no regard to faults that occur outside of a given maintenance association. The detection of such outside faults, however, is likely to be useful to nodes implementing Y.1731 and/or 802.1ag. With knowledge of a particular outside fault, a node may wish to take action, such as rerouting traffic or propagating information of the fault onward.

While configuring a higher level maintenance association to encompass both the area of a possible outside fault and the lower maintenance association would enable detection of the fault by the normal operation of Y.1731 and 802.1ag, this solution is inefficient as it introduces additional messaging overhead for the new CFM level and is only applicable to portions of the network implementing Ethernet.

For the foregoing reasons and for further reasons that will be apparent to those of skill in the art upon reading and understanding this specification, there is a need for informing nodes within a maintenance association of a fault occurring outside the maintenance association, regardless of the protocol(s) implemented outside the maintenance association.

### SUMMARY

In light of the present need for informing nodes within a maintenance association of a fault occurring outside the maintenance association, regardless of the protocol(s) implemented outside the maintenance association, a brief summary of various exemplary embodiments will be presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method and related network node including one or more of the following: receiving a first indication of the existence of a fault in a connection related to a service provided by the node on which the maintenance endpoint is configured; determining that the connection related to the service provided by the node is located outside the scope of the maintenance association by determining that at least one node at which the connection having the fault terminates does not include a maintenance endpoint belonging to the maintenance association; constructing a message packet, the message packet including a second indication of the existence of the fault; and transmitting the message packet to the at least one peer maintenance endpoint within the maintenance association.

It should be apparent that, in this manner, various exemplary embodiments allow for the propagation of outside fault information by a maintenance endpoint to other maintenance endpoints within a maintenance association. In particular, by including outside fault information in a message communicated to other maintenance endpoints, these maintenance endpoints may elect to take appropriate action in response to the outside fault.

### BRIEF DESCRIPTION OF THE DRAWINGS

In order to better understand various exemplary embodiments, reference is made to the accompanying drawings, wherein:

FIG. 1 is a schematic diagram showing an exemplary network including a maintenance association and an outside fault;

FIG. 2 is a schematic diagram of an exemplary node capable of providing connectivity fault management in the network of FIG. 1;

FIG. 3 is a schematic diagram of an exemplary portion of a connectivity fault management header highlighting the four reserved flag bits;

FIG. 4 is a schematic diagram of an exemplary type-length-value field for use in a packet header; and

FIG. 5 is a flow diagram of an exemplary method for propagating outside fault information to other nodes within a maintenance association.

### DETAILED DESCRIPTION

Referring now to the drawings, in which like numerals refer to like components or steps, there are disclosed broad aspects of various exemplary embodiments.

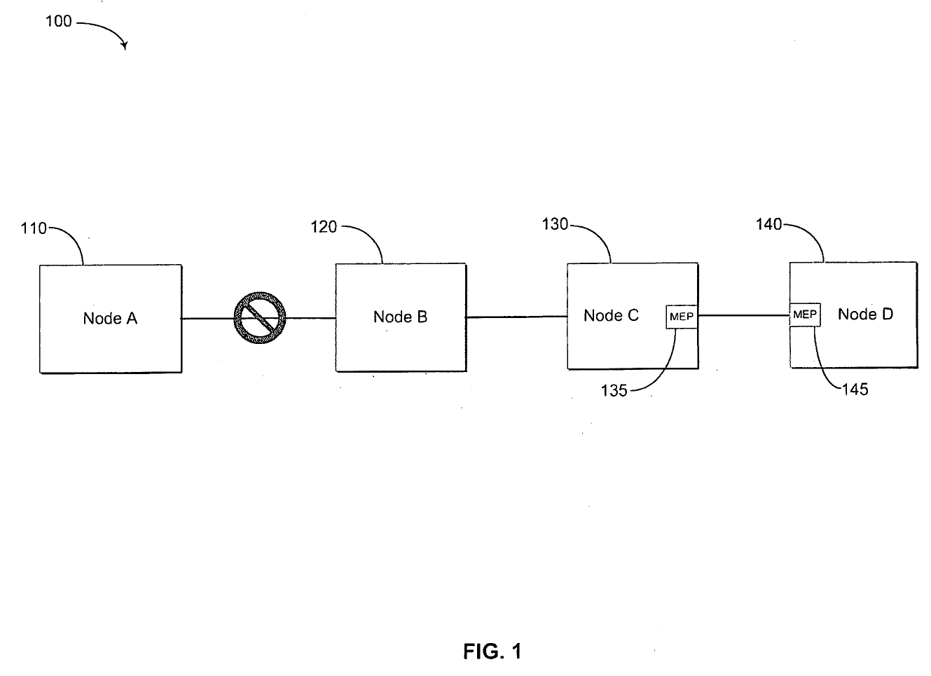

FIG. 1 is a schematic diagram of an exemplary network 100 including a maintenance association and an outside fault. Network 100 includes node A 110, node B 120, node C 130, and node D 140, each of which may be a router, switch, or other network equipment. Node A 110 and Node B 120 may normally be in communication with one another, utilizing any communications protocol such as, for example, Ethernet, Frame-Relay, or Multi-Protocol label switching (MPLS). It should be appreciated that any number of intermediate nodes may physically serve the connection between node A 110 and node B 120. As indicated by the diagram, there is currently a fault in the connection between node A 110 and node B 120.

Node B 120 and Node C 130 may be in communication with one another, utilizing any communications protocol such as, for example, Ethernet, Frame-Relay, or Multi-Protocol label switching. It should be appreciated that any number of intermediate nodes may physically serve the connection between node B 120 and node C 130.

Node C 130 and node D 140 may be in communication with one another, utilizing the Ethernet protocol. It should be appreciated that various other network elements may physically serve the connection between node C 130 and node D 140. Further, node C 130 and node D 140 may be configured to implement Ethernet Connectivity Fault Management (CFM). More specifically, node C 130 and node D 140 may implement fault detection, fault verification, fault isolation, and fault notification by exchanging CFM messages with each other.

In order to utilize node C 130 and node D 140 to exchange CFM messages, a series of configuration steps are performed on both node C 130 and node D 140. In particular, on both node C 130 and node D 140, an operator or other entity configures a maintenance domain (MD), maintenance associations (MAs), and maintenance endpoints (MEPs). As shown, a MEP 135 has been configured on node C 130 on the port that connects to node D 140. Likewise, a MEP 145 has been configured on node D 140 on the port that connects to node C 130. Thus, exemplary network 100 includes a simple maintenance association composed of MEPs 135, 145.

According to various exemplary embodiments, node B 120 will detect the fault in its connection to node A 110 and propagate this information to node C 130 according to current methods. This propagation of information from node B 120 to node C 130 may be accomplished in any manner known to those of skill in the art. Upon receiving information about the fault from node B 120, node C 130 will determine that the fault lies outside the maintenance association and is related to a service provided by node D 140. Node C 130 will then construct a continuity check message (CCM) with information about the fault and send the CCM to node D 140, thereby informing node D 140 of the outside fault. The operation of node C 130 will be described in further detail below with regard to FIGS. 3-5.

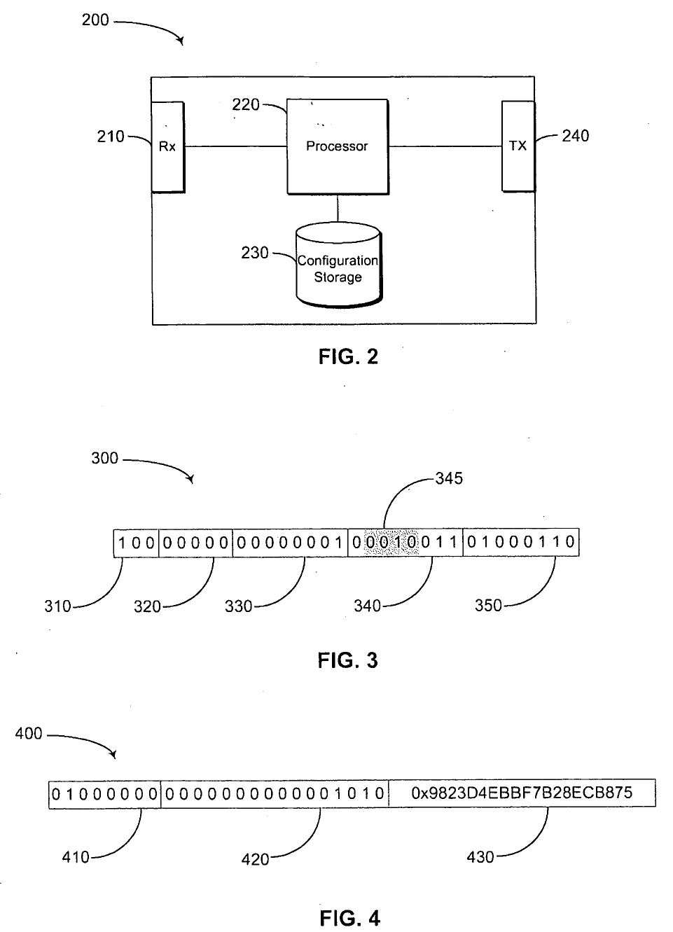

FIG. 2 is a schematic diagram of an exemplary node 200 capable of providing CFM in the network 100 of FIG. 1. Node 200 may be a router, switch, or other network equipment supporting Ethernet OAM. Node 200 may correspond to node C 130 and/or node D 140. Node 200 may include a receiver 210, processor 220, configuration storage 230, and a transmitter 240.

Receiver 210 may include hardware and/or executable instructions encoded on a machine-readable storage medium configured to receive data from another network node. The hardware included in receiver 210 may be, for example, a network interface card that receives packets and other data. Thus, receiver 210 may receive CFM messages destined for a MEP located at node 200 or traffic packets according to some messaging protocol.

Processor 220 may include hardware and/or executable instructions encoded on a machine-readable storage medium configured to implement CFM functionality on node 200. Thus, configuration module 220 may include a microprocessor, Field Programmable Gate Array (FPGA), or similar hardware. In addition, configuration module 220 may include a storage medium containing machine-executable instructions. In either case, this hardware may be standalone or part of a central processor (not shown) of node 200 or, alternatively, implemented in a line card or port-distributed object. Other suitable implementations will be apparent to those of skill in the art.

Configuration storage 230 may be maintained on a machine-readable storage medium and includes all configuration information used by processor 220. Thus, configuration storage 230 may include a database, linked-list, array, or any other data structure or arrangement suitable for storage of configuration information. Configuration storage 230 may include CFM objects, which maintain information regarding all domains, associations, local MEPs, and remote MEPs used by node 200. Configuration storage 230 may further include MAC addresses, which indicate the MAC address of each remote MEP with which a point-to-point connection has been established.

Transmitter 240 may include hardware and/or software encoded on a machine-readable storage medium configured to transmit data to another network node. The hardware included in transmitter 240 may be, for example, a network interface card that transmits packets and other data. Thus, transmitter 240 may transmit CFM messages destined for a remote MEP over a network connection such as, for example, Ethernet or Point-to-Point Protocol. As an example, transmitter 240 may send a Continuity Check Message (CCM) using a format described in further detail below with reference to FIGS. 3-4.

FIG. 3 is a schematic diagram of an exemplary portion of a CFM header 300 highlighting the four reserved flag bits 345. CFM header 300 may include MD Level field 310, version field 320, operation code (opcode) field 330, flags field 340, and first TLV offset field 350. Flags field 340 may further include reserved flags 345. CFM header 300 may be included in the header of a CFM packet such as, for example, a CCM.

For exemplary CFM header 300, MD level field 310 is set to binary “100,” indicating the CCM is for use on the fourth maintenance domain level. Version field 320 is set to zero and opcode field 330 is set to one, indicating a CCM. First TLV offset field 350 is set to binary “01000110,” indicating an offset of 70 octets, as is standard for CCMs.

Flags field 340 includes a highest order bit flag set to zero and three lowest order flags set to “011.” Flags field 340 further includes four reserved flags 345, which are not used in current standards. According to various embodiments, one flag of the four reserved flags 345 is set to one in order to indicate the detection of a total outside fault, wherein all connectivity between two nodes is lost. According to various further embodiments, another flag of the four reserved flags 345 is set to one in order to indicate the detection of a partial outside fault, wherein only a portion of the connectivity between two nodes is lost. A partial fault may occur, for example, when only a subset of the links in a physical link bundle are faulty, leaving the corresponding logical link operational, but with diminished throughput capacity.

It should be apparent that the use of a CCM is not necessary to propagate fault information. The reserved flags of any CFM packet may be used to indicate a total or partial outside fault to other MEPs.

FIG. 4 is a schematic diagram of an exemplary type-length-value (TLV) field 400 for use in a packet header. TLV field 400 may include detailed outside fault information and may include type field 410, length field 420, and value field 430. For exemplary TLV field 400, type field 410 is set to binary “01000000,” indicating type number 64. It should be apparent that type field 410 may be set to any value that a receiving MEP will recognize as signaling fault information. Length field 420 may indicate the length, in octets, of value field 430. For example, length field 420 is set to binary “1010,” indicating that value field 430 is 10 octets long.

Value field 430 may include detailed information about a detected outside fault. For example, value field 430 is set to hexadecimal “9823 D4EB BF7B 28EC B875” which may indicate detailed fault information such as, for example, the location of the entity that initially detected the fault, the protocol of the faulty connection, or the time of fault detection.

The detailed fault information may be encoded in predetermined octets or other sized portions of the value field 430, such that a receiving node 140 will be aware of the meaning of a particular set of data based solely on its location. For example, if the first eight octets of the value field 430 were predetermined to represent the IP address of the entity that initially detected the fault, value field 430 would then indicate that a fault was initially detected by an entity with IP address 0×9823D4EB, or 152.35.212.235. Alternatively, the meaning of data ill the value field 430 may not be location dependent, but instead depend on a more complex data structure. The data in value field 430 may, for example, include other TLV fields for each piece of detailed information. Upon receipt of a message containing TLV field 400, the receiving node 140 may decode value field 430 according to whatever encoding standard has been previously determined.

TLV field 400 may be inserted into the header of a CFM packet such as, for example, a CCM. It should be apparent that TLV field 400 could be inserted into virtually any packet header in order to send detailed fault information to other MEPs within an MA, such as, for example, a loopback message or a linktrace message.

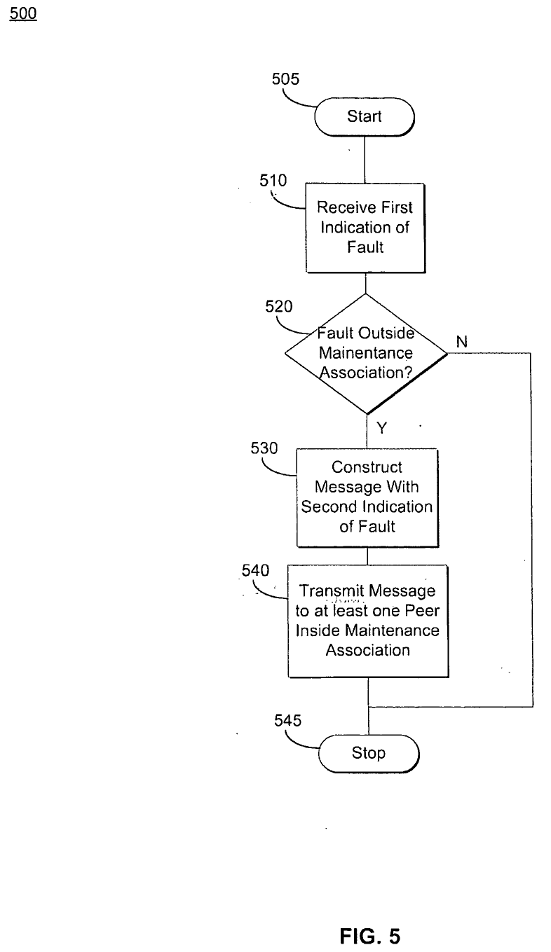

FIG. 5 is a flow diagram of an exemplary method 500 for propagating outside fault information to other nodes within a maintenance association. Exemplary method 500 may be implemented on node C 130 or processor 220 of node 200.

Method 500 starts at step 505 and proceeds to step 510 where a first indication of a fault is received. This first indication may be in any form such as, for example, a pseudowire status notification message. The first indication may arrive in response to a previous probe for faults by the node or may be an unsolicited message from another node that has knowledge of the fault. After receiving this first indication, method 500 moves to step 520.

At step 520, method 500 determines whether the fault is outside of a maintenance association to which the node belongs. This determination may be made by actively locating the fault and comparing the location to stored information about the MA or simply inferred from the port or interface over which the indication arrived. If the fault is determined not to be an outside fault, method 500 terminates at step 545. Method 500 may additionally determine at step 520 whether the fault is located in a connection related to a service provided by the nodes in the maintenance association. In this case, the fault notification will only be propagated through maintenance associations containing nodes that provide a service related to the outside fault.

If the fault is determined at stop 520 to be an outside fault, method 500 moves on to step 530, where it constructs a message with a second indication of the fault. The message may be any message suitable for conveying fault information. The message may be a CFM message such as, for example, a CCM or it may be any other packet capable of being sent to another node. The second indication of the fault may include any combination of a total fault flag, a partial fault header flag, a detailed fault information header field, and detailed information included in the body of the message. A total fault flag and a partial fault flag may utilize reserved bits of a flag field, as described above with reference to FIG. 3. A detailed fault information header field may be a TLV field as described above with reference to FIG. 4.

After construction of the message in step 530, method 500 moves to step 540 where the message is sent to at least one other MEP within the MA. After receipt, the at least one other MEP will be informed as to the presence of an outside fault and may respond accordingly. For example, a node learning of an outside fault may attempt to reroute traffic, store the fault information for user review, or propagate the fault information to other nodes. After transmission, method 500 will terminate at step 545.

As an example, consider exemplary network 100, described with reference to FIG. 1. Assume that the connection between node A 110 and node B 120 is a frame-relay connection and that the connection between node B 120 and node C 130 is an MPLS pseudowire. When node B 120 detects a total fault in its frame-relay connection with node A 110, it may propagate fault information over the MPLS pseudowire connected to node C 130 according to current methods, such as pseudowire status notification. Once node C 130 receives this notification of the fault, it may infer that, because node B 120 sent the notification, the fault exists outside the maintenance association including MEPS 135, 145. Node C 130 may also determine that node D 140 provides a service related to the outside fault and should therefore be informed of the fault. Then, upon construction of the next CCM, node C 130 may set the total fault flag in the CFM header and include a TLV field containing more detailed information about the fault. Node C 130 may then send the CCM to MEP 145 on node D 140, which will then be able to take appropriate action.

According to the foregoing, various exemplary embodiments allow for the propagation of outside fault information to other nodes within a maintenance association. In particular, by including information pertaining to a fault detected outside a maintenance association in the header of a message transmitted to other nodes within the maintenance association, such as a continuity check message, the other nodes may be informed of the presence of the outside fault and take action accordingly. Furthermore, the resources required for implementation and operation are minimal, as the various exemplary embodiments do not require the establishment of additional maintenance associations.

It should be apparent from the foregoing description that various exemplary embodiments may be implemented in hardware, firmware, and/or software. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a network node (e.g. router or switch). Thus, a machine-readable storage medium may include read-only memory (ROM), random-access memory (RAM), magnetic disk storage media, optical storage media, flash-memory devices, and similar storage media.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications may be implemented while remaining within the spirit and scope of the invention. Accordingly, the foregoing disclosure, description, and figures are for illustrative purposes only and do not in any way limit the invention, which is defined only by the claims.

What is claimed is:

1. A method of propagating fault information by a maintenance endpoint configured on a node in a communications network and belonging to a maintenance association to at least one peer maintenance endpoint within the maintenance association, the method comprising:
receiving a first indication of the existence of a fault in a connection related to a service provided by the node on which the maintenance endpoint is configured;
determining that the connection related to the service provided by the node is located outside the scope of the maintenance association by determining that at least one node at which the connection having the fault terminates does not include a maintenance endpoint belonging to the maintenance association;
constructing a message packet, the message packet including a second indication of the existence of the fault; and
transmitting the message packet to the at least one peer maintenance endpoint within the maintenance association.

2. The method of claim 1, wherein the message packet is a continuity check message.

3. The method of claim 2, wherein the second indication of the existence of the fault comprises a flag set in the continuity check message header.

4. The method of claim 2, wherein the second indication of the existence of the fault comprises two flags set in the continuity check message header and indicates the detection of at least one of a total fault and a partial fault.

5. The method of claim 2, wherein the second indication of the existence of the fault comprises a type-length-value field included in the continuity check message.

6. The method of claim 5, wherein the type-length-value field comprises detailed fault information.

7. The method of claim 1, wherein the message packet comprises detailed fault information.

8. A node in a communications network configured to include a maintenance endpoint belonging to a maintenance association and capable of propagating fault information to at least one peer maintenance endpoint within the maintenance association, the node comprising:
a first network interface for receiving a first indication of the existence of a fault in a connection related to a service provided by the node;
a processor configured to:
determine that the connection related to the service provided by the node is located outside the scope of the maintenance association by determining that at least one node at which the connection having the fault terminates does not include a maintenance endpoint belonging to the maintenance association, and
construct a message packet, the message packet including a second indication of the existence of the fault; and
a second network interface for transmitting the message packet.

9. The node of claim 8, wherein the message packet is a continuity check message.

10. The node of claim 9, wherein the second indication of the existence of the fault comprises a flag set in the continuity check message header.

11. The node of claim 9, wherein the second indication of the existence of the fault comprises two flags set in the continuity check message header and indicates the detection of at least one of a total fault and a partial fault.

12. The node of claim 9, wherein the second indication of the existence of the fault comprises a type-length-value field included in the continuity check message.

13. The node of claim 12, wherein the type-length-value field comprises detailed fault information.

14. The node of claim 8, wherein the message packet comprises detailed fault information.

15. A machine-readable storage medium encoded with instructions for propagating fault information by a maintenance endpoint configured on a node in a communications network and belonging to a maintenance association to at least one peer maintenance endpoint within the maintenance association, the machine-readable storage medium comprising instructions for;
receiving a first indication of the existence of a fault in a connection related to a service provided by the node on which the maintenance endpoint is configured;
determining that the connection related to the service provided by the node is located outside the scope of the maintenance association by determining that at least one node at which the connection having the fault terminates does not include a maintenance endpoint belonging to the maintenance association;
constructing a message packet, the message packet including a second indication of the existence of the fault; and
transmitting the message packet to the at least one peer maintenance endpoint within the maintenance association.

16. The machine-readable storage medium of claim 15, wherein the message packet is a continuity check message.

17. The machine-readable storage medium of claim 16, wherein the second indication of the existence of the fault comprises a flag set in the continuity check message header.

18. The machine-readable storage medium of claim 16, wherein the second indication of the existence of the fault comprises two flags set in the continuity check message header and indicates the detection of at least one of a total fault and a partial fault.

19. The machine-readable storage medium of claim 16, wherein the second indication of the existence of the fault comprises a type-length-value field included in the continuity check message.

20. The machine-readable storage medium of claim 19, wherein the type-length-value field comprises detailed fault information.
